(19) United States
(12) Patent Application Publication
(10) Pub. No.: US 2007/0228950 A1
(43) Pub. Date: Oct. 4, 2007

(54) Lamp tube of a covered bulb and its manufacturing method

(76) Inventors: Jianbo Liao, Dongyang (CN); Fuyuan Qiu, Dongyang (CN); Linkun Fei, Dongyang (CN)

Correspondence Address: JACOBSON HOLMAN PLLC, 400 SEVENTH STREET N.W., SUITE 600, WASHINGTON, DC, 20004, US

(21) Appl. No.: 11/727,827

(22) Filed: Mar. 28, 2007

(30) Foreign Application Priority Data
Mar. 28, 2006 (CN) 200610050056.3

(51) Int. Cl. H01J 61/24; H01J 17/22; H01J 19/70; H01K 1/52

(52) U.S. Cl. 313/545

(57) ABSTRACT

The present invention discloses a lamp tube of a covered bulb, including a lamp body and a core column, with a filament and an exhaust pipe on the core column, characterized in that the exhaust pipe has a bent shape. The lamp tube of the covered bulb of the present invention can reduce the working temperature of the amalgam, and increase the difference between melting temperature and working temperature of the amalgam. Besides, it can also avoid the flow of the melted amalgam when the lamp is on for a long time. It is important that the lamp tube of the covered bulb for the invention can ensure that the amalgam is at the optimum working temperature, the saturated mercury vapor pressure reaches the optimum state, whereby the consistence of photo-electricity parameter will be considerably increased. It can increase the luminous flux maintaining rate for the whole lamp to prolong the service life of the lamp, because the lamp tube of the covered bulb of the invention is often placed downward during use. The amalgam cannot flow towards the lamp tube after it melts. The structure of the exhaust pipe of the lamp will limit the flow of the amalgam. The operation is simple during assembling, easy to learn and the cost is low.

### FIELD OF THE INVENTION

The present invention relates to a type of compact fluorescent lamp, especially a lamp tube of a covered bulb and its manufacturing method.

### DESCRIPTION OF THE RELATED ART

Presently, amalgam is often used to adjust the saturation pressure of the mercury vapor in the covered bulb in industrial manufacturing processes of compact fluorescent lamp tubes. Because the temperature of the energy-saving lamp tube in the covered bulb is high, the selected amalgam is usually BiInHg having a high working temperature in order to reach the optimum saturation pressure of the mercury vapor. However, during long term use, due to low melting temperature of BiInHg, the amalgam in the covered bulb melts. This causes change in the saturation pressure of the mercury vapor, which results in the variation of the photo-electricity parameter and directly affects the consistency of the luminous flux maintaining rate. Although a sample lamp tube can meet the requirements of its design from time to time, the quality of the lamp tube varies greatly during batch production. This adversely affects the users. In order to solve this problem, Toshiba Co., Ltd in Japan has used a lengthened exhaust pipe to reduce the working temperature of amalgam, and selected a suitable middle temperature of amalgam. However, after the exhaust pipe is lengthened, the core column and exhaust pipe have to meet more stringent requirement as to their degree of straightness. At the same time, this solution causes extreme inconvenience in the assembly process of a whole lamp.

### SUMMARY OF THE INVENTION

The present invention is provided to overcome the inherent defect of easy melting of amalgam in a covered bulb. In addition, the present invention provides one new rough tube production method, and resolves the difficulty in the rough tube production and whole lamp assembly so as to increase the consistency of luminous flux maintaining rate for the covered bulb and prolong the service life of the lamp tube.

In order to solve the technical problems of amalgam melting, the following technical solution is proposed in the present invention: a lamp tube of a covered bulb, including a lamp body and a core column, with a filament and an exhaust pipe on the core column, characterized in that the exhaust pipe is formed to a bent shape.

The lamp tube of the covered bulb of the present invention can reduce the working temperature of amalgam and increase the difference between melting temperature and working temperature of amalgam. In addition, it can prevent the amalgam from flowing after melting when the lamp is on for a long time. It is important that the lamp tube of the covered bulb of the present invention can ensure that the amalgam is at an optimum working temperature, the mercury vapor saturation pressure reaches the optimum state, and the consistency of photo-electricity parameter is considerably increased. It is a great advantage to increase luminous flux maintaining rate for the whole lamp to prolong the service life of the lamp. The lamp tube of the covered bulb of the present invention is often placed downward during use. However, due to the structural characteristics of the lamp tube of the present invention, the amalgam will not flow towards the lamp tube after the amalgam lamp is used for a long time even if the amalgam melts. The operation to assemble the lamp is simple, easy to learn and the cost is low.

The above mentioned exhaust pipe is the exhaust pipe in the core column. The above mentioned bent shape has an angle α which is preferably 5-150°. The vertical distance B, which is measured from the sealing surface of the lamp body and the core column to the bend defined by a line that is parallel to the sealing surface and tangent to a periphery of the bend that is distal from the sealing surface, is preferably 2-20 mm. The vertical distance A, which is measured from a line that is normal to the sealing surface of the lamp body and the core column and tangent to a periphery of the distal end of the exhaust pipe, to a second line that is parallel to the first line and tangent to the proximal end of the exhaust pipe, is preferably 2-30 mm.

As a further improvement of the present invention, the exhaust pipe is further shaped by a second bend. The vertical length C of the distal section of the exhaust pipe, which is measured from a first line that is parallel to the sealing surface of the lamp body and the core column and tangent to an outer periphery of the exhaust pipe at the second bend, to a second line that is parallel to the first line and tangent to the distal end of the exhaust pipe, is preferably 2-50 mm.

For the lamp tube of the covered bulb of the present invention, the effect of double bend of the exhaust pipe is the same as that of single bend. To use a double bend or single bend is decided according to different exhaust equipment. If the space in front of or behind the exhaust table is large and the temperature is low, a single bend is sufficient. The double bend is mainly to place the mercury fork pipe under the exhaust table and to ensure that the temperature at the position of amalgam is not high (such as less than 40° C.), in order to avoid mercury loss which would influence the performance of the amalgam caused by volatilization during an exhaustion process. The amalgam may be placed at the first bend section, or at the second bend section. The difference of two sites is mainly the different temperature selected for the amalgam. There is no significant difference in its performance.

The present invention also provides a manufacturing method of a lamp tube of a covered bulb, including the steps of fluorescent powder coating, tube broiling, wire rolling and powder bonding of a core column, final encapsulation, connecting fork, exhausting, blanking etc., characterized in that the exhaust pipe of the core column is formed to have a shape with at least one bend, and the angle α of the first bend is 5-150°, the vertical distance B, which is measured from the sealing surface to the bending position or a line that is parallel to the sealing surface and tangent to a periphery of the bend that is distal from the sealing surface, is 2-20 mm, the vertical length A, which is measured from a line that is normal to the sealing surface of the lamp body and the core column and tangent to a periphery of the distal end of the exhaust pipe, to a second line that is parallel to the first line and tangent to the proximal end of the exhaust pipe, is 2-30 mm.

The lamp tube of the present invention may be applied to any fluorescent lamp, in particular, an energy-saving covered bulb.

### BRIEF DESCRIPTION OF THE DRAWINGS

The present invention shall be further described in combination with the implementation examples.

FIGS. 1a-1e show the conventional lamp tube structure and manufacturing process.

FIG. 2 is a schematic drawing showing the structure of the core column.

FIG. 3 is a schematic drawing showing an embodiment where the exhaust pipe for the lamp tube is bent once according to the present invention.

FIG. 4 is a schematic drawing showing another embodiment where the exhaust pipe for the lamp tube is bent twice according to the present invention.

FIG. 5 shows the lamp tube structure and manufacturing process of the present invention.

### DETAILED DESCRIPTION OF THE INVENTION

The reference numerals in the drawings have the following meanings: 1. powder tube, 2. core column, 3. exhaust pipe, 4. filament, 5. filament lead, 6. fork tube, 7. amalgam, 8. rough tube, 9. fluorescent powder.

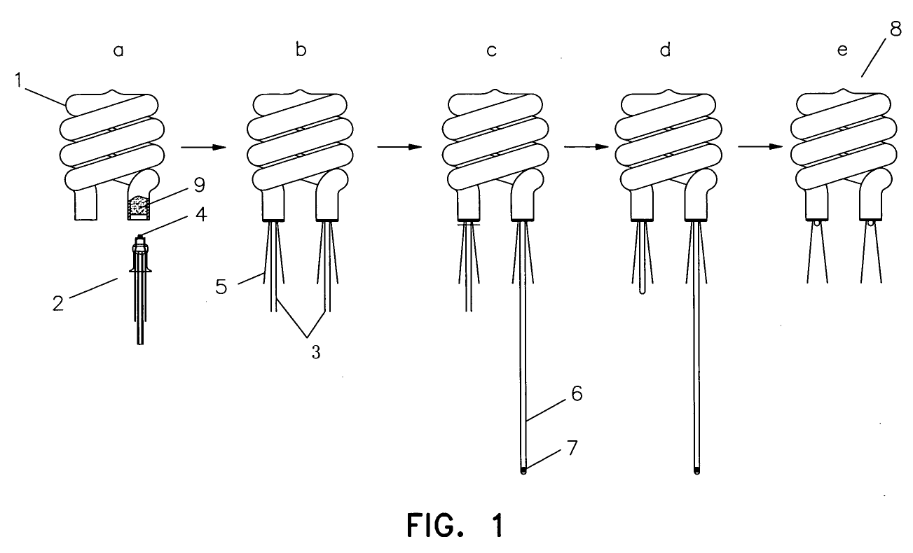

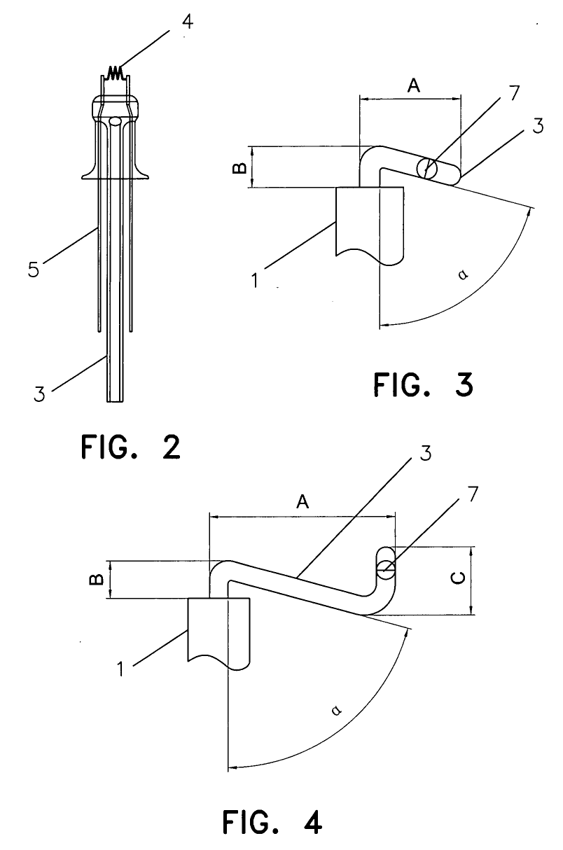

With reference to FIGS. 1 and 2, the conventional fluorescent lamp tube includes a tube body (1, 8) and a core column (2). The core column is provided with a filament and an exhaust pipe. An open lamp tube is processed to make a rough tube according to the following steps.

1. Fluorescent powder coating: a fluorescent powder slurry formed by mixing fluorescent powders, adhesive and other auxiliary material is evenly coated on the inside surface of an open tube.

2. Tube broiling: the coated tube is heated to make the adhesive completely decompose. The fluorescent powder is firmly adhered to the inside surface of the open tube to form a coated tube, as shown in FIG. 1, Step a.

3. Wire rolling and powder bonding of the core column: three screw filaments are assembled at a nickel support of the core column and a ternary carbonate powder slurry is coated on the filament.

4. Encapsulation: the core column provided with the filament and the coated tube are heated by a flame to complete the butt-joint procedure in order to make the core column safely and firmly fixed to the end of the coated tube. Then the coated tube is linked with the outside through an exhaust pipe, as shown in FIG. 1, Step b.

5. Connecting fork tube: The amalgam is preinstalled in a fork tube that is sealed on one side. The open side is butt-joined with the exhaust pipe, as shown in FIG. 1, Step c.

6. Exhaustion: the coated tube connected with the fork tube is heated and vacuum-pumped by exhaustion equipment, and then the filament is electrified to make the ternary carbonate sufficiently decomposed and activated to form surplus barium ions, as shown in FIG. 1, Step d.

7. Blanking off the tube: the end of the exhaust pipe that is connected with the vacuum pipe is heated to melt and break. The amalgam in the fork tube moves to the end of the coated tube, and the exhaust pipe is heated to melt and break, as shown in FIG. 1, Part e.

8. Post processing: The coated tube after vacuum pumping is processed through aging, cleaning and inspection steps and formed into a finished rough tube. After other assembling parts such as plastic pieces, wiring panel and lamp holder are installed, the rough tube is assembled into a whole lamp.

It may be seen from the drawings that the exhaust pipe of the core column for the existing rough tube of a fluorescent lamp is a straight pipe. Its defect has been mentioned above and will not repeated again.

### EXAMPLE 1

With reference to FIG. 3, the fluorescent lamp tube of the present invention is improved based on the existing technology. At first, a sealed rough tube with an exhaust pipe is provided. Then, the exhaust pipe is bent to form an angle α of 60°, where the height B (the length between the sealing surface of the tube body and core column to the bent position) is 5 mm and the length A (the length/distance from the bent position, including the diameter of the exhaust pipe, to the distal end of the exhaust pipe) is 20 mm. Next, the steps of connecting the fork tube, exhaustion, blanking off the tube and post processing are completed in accordance with a conventional process. However, during the blanking off the tube step, the amalgam shall be positioned at the bent section to make a R40, 23 W energy-saving lamp tube, as shown in FIG. 5, Step e. Its average value of primary luminous flux is 1400 Lm. Its average luminous flux maintaining rate is 83%/4000 hours. Its service life reaches 10000 hours.

### EXAMPLE 2

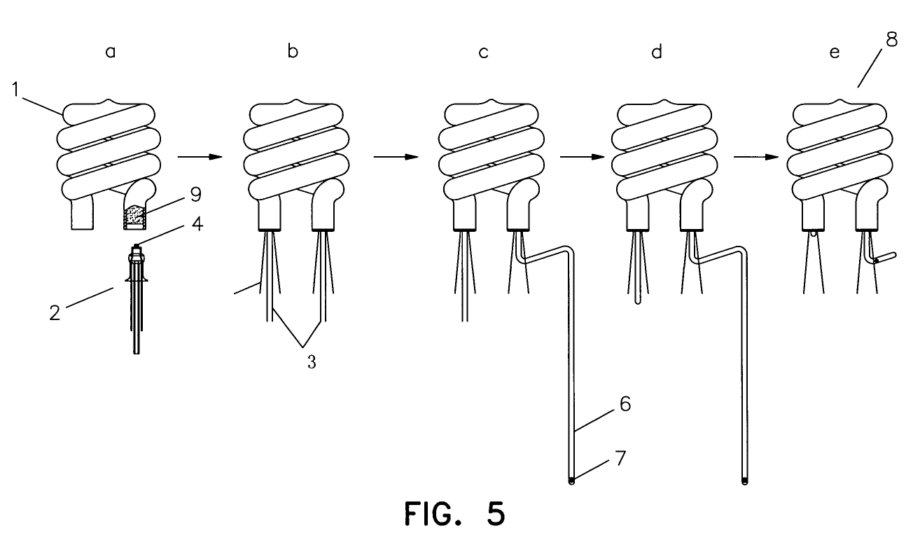

With reference to FIG. 4, a sealed rough tube with an exhaust pipe is provided. The exhaust pipe is bent twice to form a “Z” shape, wherein the distance B of the first bend is 2 mm, the length A is 30 mm and the angle α is 90°. The length C of the second bend (the length/distance from the second bend, including outer periphery of the exhaust pipe, to the distal end of the exhaust pipe) is 2 mm. Then, the steps of connecting the fork tube, exhaustion, blanking off the tube and post processing are completed in accordance with a normal process. However, during the blanking off the tube step, the amalgam shall be positioned at the second bend section to make a R40, 23 W energy-saving lamp tube. Its average value of primary luminous flux is 1350 Lm. Its average luminous flux maintaining rate is 84%/4000 hours. Its service life reaches 10000 hours.

### EXAMPLE 3

With reference to FIG. 4, a sealed rough tube with an exhaust pipe is provided, the exhaust pipe is bent twice to form a “Z” shape, wherein the length B of the first bend is 20 mm, the length A is 5 mm and the angle α is 80°. The length C of the second bend is 25 mm. Then, the steps of connecting the fork tube, exhaustion, blanking off the tube and post processing are completed in accordance with a normal process. However, during the blanking off the tube step, the amalgam shall be positioned at the second bend section to make a R40, 23 W energy-saving lamp tube. Its average value of primary luminous flux is 1380 Lm. Its average luminous flux maintaining rate is 82%/4000 hours. Its service life reaches 10000 hours.

### EXAMPLE 4

With reference to FIG. 4, a sealed rough tube with an exhaust pipe is provided. The exhaust pipe is bent twice into a “Z” shape, wherein the length B of the first bend is 6 mm, the length A is 25 mm and angle α is 50°. The length C of the second bend is 50 mm. Then, the steps of connecting the fork tube, exhaustion, blanking off the tube and post processing are completed in accordance with a conventional process. However, during the blanking off the tube step, the amalgam shall be positioned at the second bend section to make a R40, 23 W energy-saving lamp tube. Its average value of primary luminous flux is 1370 Lm. Its average luminous flux maintaining rate is 81%/4000 hours. Its service life reaches 10000 hours.

### EXAMPLE 5

With reference to FIG. 3, a sealed rough tube with an exhaust pipe is provided. The exhaust pipe is bent one time, wherein the length B is 20 mm, the length A is 2 mm and the angle α is 5°. Then, the steps of connecting the fork tube, exhaustion, blanking off the tube and post processing are completed in accordance with a normal process. However, during the blanking off the tube step, the amalgam shall be positioned at the bend section to make a R40, 23 W energy-saving lamp tube. Its average value of primary luminous flux is 1350 Lm. Its average luminous flux maintaining rate is 83%/4000 hours. Its service life reaches 10000 hours.

### EXAMPLE 6

With reference to FIG. 3, a sealed rough tube with an exhaust pipe is provided. The exhaust pipe is bent one time, wherein the length B is 15 mm, the length A is 30 mm and the angle α is 150°. Then, the steps of connecting the fork tube, exhaustion, blanking off the tube and post processing are completed in accordance with a normal process. However, during the blanking off the tube step, the amalgam is positioned at the bend section to make a R40, 23 W energy-saving lamp tube. Its average value of primary luminous flux is 1340 Lm. Its average luminous flux maintaining rate is 82%/4000 hours. Its service life reaches 10000 hours.

TABLE 1

| | | 4000 h luminous flux | | |
|---|---|---|---|---|
| | 100 h luminous | maintaining rate | 4000 h luminous flux | Service life |
| No. | flux (lm) | (%) (max) | (%) (min) | (h) |
| Example 1 | 1400 | 84 | ≧81 | ≧10000 |
| Example 2 | 1350 | 86 | ≧82 | ≧10000 |
| Example 3 | 1380 | 84 | ≧81 | ≧10000 |
| Example 4 | 1370 | 83 | ≧80 | ≧10000 |
| Example 5 | 1350 | 85 | ≧80 | ≧10000 |
| Example 6 | 1340 | 83 | ≧80 | ≧10000 |
| Comparison | 1340 | 84 | ≧70 | ≧8000 |
| example 1 | | | | |
| Comparison | 1360 | 83 | ≧72 | ≧8000 |
| example 2 | | | | |

Table 1 is a comparison table showing the performance of the amalgam lamp made according to the present invention and that of the conventional method. In Table 1, each group sample for tests included 10 lamps. The Implementation examples 1-6 are six test groups of the present invention with different length B, length A, angle α and second bend length C. It can be seen from Table 1 that the consistency of the luminous flux maintaining rate is considerably increased and the service life is guaranteed by means of the method of the present invention.

As for the above-mentioned rough tube of a fluorescent lamp, only one side is connected with a fork tube, and the other side is directly vacuum-pumped from the exhaust pipe. In other embodiments, each of the two sides of the exhaust pipe for rough tube of a fluorescent lamp is connected with a fork tube. One side of vacuum pumping of the exhaust pipe is connected with the fork tube by a three-way pipe, and the vacuum pumping is performed from a lateral pipe of the three-way pipe. The fluorescent lamp tube of the present invention is also suited to this structure fluorescent lamp tube and its manufacturing method, and can achieve the same technical result.

It should be understood that the above-mentioned examples are only exemplary of the invention and not limiting.

What is claimed is:

1. A fluorescent lamp tube of covered bulb, comprising:
a tube body having an opening;
a core column connected to the opening of the tube body;
a filament provided on the core column and located inside of the tube body; and
an exhaust pipe provided on the core column and extended beyond the tube body;
wherein the exhaust pipe is formed with a bent shape.

2. The lamp tube of a covered bulb according to claim 1, wherein a bent angle of the exhaust pipe is 5-150°.

3. The lamp tube of a covered bulb according to claim 1, wherein the vertical distance, which is measured from a sealing surface of the tube body and the core column to the bend defined by a line that is parallel to the sealing surface and tangent to a periphery of the bend that is distal to the sealing surface, is about 2-20 mm.

4. The lamp tube of a covered bulb according to claim 1, wherein the vertical distance, which is measured from a line that is normal to the sealing surface of the tube body and the core column and tangent to a periphery of the distal end of this exhaust pipe, to a second line that is parallel to the first line and tangent to the proximal end of the exhaust pipe, is about 2-30 mm.

5. The lamp tube of a covered bulb according to claim 1, wherein the exhaust pipe is bent twice to form a “Z” shape.

6. The lamp tube of a covered bulb according to claim 5, wherein the vertical length of the section of the exhaust pipe, which is measured from a first line that is parallel to the sealing surface of the tube body and the core column and tangent to an outer periphery of the exhaust pipe at the second bend, to a second line that is parallel to the first line and tangent to the end of the exhaust pipe that is not connected to the tube body, is about 2-50 mm.

7. The lamp tube of a covered bulb according to claim 4, wherein a amalgam is placed in a section of the exhaust pipe that is between the bend and the end of the exhaust pipe that is not connected to the tube body.

8. The lamp tube of a covered bulb according to claim 5, wherein a amalgam is placed at a section of the exhaust pipe that is between a second bend with respect to a sealing surface of the tube body and the core column, and the end of the exhaust pipe that is not connected to the tube body.

9. A method of manufacturing a lamp tube for a covered bulb according to claim 1, comprising the steps of: coating a fluorescent powder onto an inside surface of a tube to form a coated tube, broiling the coated tube, mounting a filament onto a core column having an exhaust pipe and applying a ternary carbonate powder slurry to the filament, encapsulating and sealing the coated tube with the core column, placing a amalgam in a one end-sealed fork tube and connecting an open end of the fork tube with the exhaust pipe, heating and vacuuming the coated tube, heating the exhaust pipe to melt and sealing the exhaust pipe, wherein the exhaust pipe of the core column is formed to a shape having at least one bend, and the angle of a first bend is 5-150°, the distance from a sealing surface between the coated tube and the core column to the first bend is 2-20 mm, and the distance from the first bend position to one end of the exhaust pipe that is not connected to the coated tube is 2-30 mm.
